(19) United States
(12) Patent Application Publication
(10) Pub. No.: US 2013/0210566 A1
(43) Pub. Date: Aug. 15, 2013

(54) CHAIN GUIDE FOR TRANSMISSION DEVICE

(71) Applicant: TSUBAKIMOTO CHAIN CO., (US)

(72) Inventor: Masahiko Konno, Osaka (JP)

(73) Assignee: TSUBAKIMOTO CHAIN CO., Osaka (JP)

(21) Appl. No.: 13/741,457

(22) Filed: Jan. 15, 2013

(30) Foreign Application Priority Data
Feb. 10, 2012 (JP) 2012-027673

(51) Int. Cl. F16H 7/18

(52) U.S. Cl. CPC F16H 7/18
USPC 474/111

(57) ABSTRACT

In a transmission chain guide, a shoe made of synthetic resin and extending in a longitudinal direction, has a front face for sliding engagement with a transmission chain traveling in the longitudinal direction, and a back face. The guide also comprises a base made of synthetic resin and having a supporting face extending along the longitudinal direction and supporting the back face of the shoe. The shoe and the base are integrally fused together. An engaging portion of the base, integrally molded with the base, and an engaging portion of the shoe, integrally molded with the shoe, are engaged and fused with each other bidirectionally in the longitudinal direction.

### CROSS-REFERENCE TO RELATED APPLICATION

The disclosure of Japanese patent application 2012-027673, filed Feb. 10, 2012 is incorporated herein by reference.

### FIELD OF THE INVENTION

This invention relates to a chain guide for use in a transmission device, and more specifically to a chain guide in which a shoe, made of synthetic resin and having a sliding contact face on which a transmission chain slides, is fused and integrated with a base also made of synthetic resin and having a face for supporting the shoe. The chain guide can be installed, for example, in the timing transmission of an automobile engine.

### BACKGROUND OF THE INVENTION

A chain guide traditionally includes a shoe made of synthetic resin and having a front face extending in a longitudinal direction and a back face. In a transmission device, a transmission chain travels in the longitudinal direction in sliding contact with the front face of the shoe. The chain guide also includes a base made of synthetic resin and having a longitudinally extending face supporting the back face of the shoe. The shoe and the base are integrated by being fused together at a fusing portion, an area over which the back face of the shoe is in facing contact with the supporting face of the base, as described in Japanese laid-open patent application No. 2004-150615.

In a chain guide in which the base and the shoe are integrated by fusion, longitudinal shear stress is generated at the fusing portion between the base and the shoe. This shear stress is generated both by friction between the traveling chain and the shoe, and by different amounts of thermal expansion of the shoe and the base, either because the shoe and the base have different thermal coefficients or because frictional heat or changes in engine temperature cause the temperature of the shoe to differ from the temperature of the base.

Shear stress causes the strength of the integrated base and shoe to deteriorate over time. This deterioration, in turn, impairs the durability of the chain guide, which then requires more frequent maintenance.

With the recent trend toward downsizing engines and other machines utilizing transmission chains and chain guides, the space surrounding the chain guide has been reduced, and the clearance between the chain guide and adjacent components has become smaller.

In the case of a movable chain guide which is pivoted on a mounting shaft and swings about a pivot axis, there is always a clearance between the chain guide and the mounting shaft. A lateral force acting on the chain guide, for example a lateral force resulting from a slight meandering of the chain, can cause the chain guide to incline with respect to an imaginary plane to which the pivot axis is orthogonal. The inclined chain guide can come into contact with an adjacent component such as a timing chain cover or an engine block, generating noise. Repeated contact between the chain guide and adjacent components caused by lateral forces can cause abrasion, resulting in damage.

This invention addresses the above described problems, and provides a highly durable transmission chain guide in which a base made of synthetic resin and a shoe made of synthetic resin are integrated by fusion in such a way as to mitigate the deterioration in strength caused by longitudinal shear stress acting on the fused parts of the guide. The transmission chain guide can also reduce noise and abrasion caused by the contact between the chain guide and an adjacent component when the chain guide becomes inclined.

### SUMMARY OF THE INVENTION

The transmission chain guide according to the invention comprises a shoe made of synthetic resin and extending in a longitudinal direction. The shoe has a front face for sliding engagement with a transmission chain traveling in the longitudinal direction, and a back face. The guide also comprises a base made of synthetic resin and having a supporting face extending along the longitudinal direction and supporting the back face of the shoe. The shoe and the base are integrally fused together. An engaging portion of the base, integrally molded with the base, and an engaging portion of the shoe, integrally molded with the shoe, are engaged and fused with each other bidirectionally in the longitudinal direction.

Because the base and the shoe are made of synthetic resin, it is possible to reduce the weight of the chain guide and to produce the chain guide more efficiently, by integrally fusing the base and the shoe together.

Because the base and the shoe are fused together at engaging portions, the fused are is increased and the strength of the bond between the base and the shoe is improved.

Forces due to friction between the shoe and a traveling chain, and to differences in thermal expansion between the base and the shoe, are sustained not only by the fused area between the body of the shoe and the supporting portion of the base, but also by bidirectionally fused engaging portions of the shoe and the base.

Consequently, longitudinal shear stress at the fused area between the back of the base and the shoe-supporting surface of the base is decreased. Thus, the durability of the guide can be increased, and maintenance requirements can be reduced.

Unlike a chain guide in which longitudinal clearances exists between engaging portions of the base and engaging portions of the shoe, and in which the engaging portions can collide with each other as a result of fluctuations in the chain friction caused by fluctuation in chain tension, or fluctuation in the thermal expansion difference caused by repeated temperature changes, the bidirectional fusion of the engaging portions in the chain guide of the invention prevents these collisions from occurring, reduces noise caused by collisions, and prevents abrasion caused by collisions, thereby increasing the durability of the chain guide.

According to a second aspect of the invention, the engaging portion of the base comprises a plurality of engaging elements in spaced relationship to one another along the longitudinal direction of the guide. The engaging portion of the shoe comprises a number of engaging elements equal to the number of the engaging elements of the base, also in spaced relationship to one another along the longitudinal direction of the guide. Each of the engaging elements of the base is one of a hollow space and a projection, and each of the engaging elements of the shoe is one of a hollow space and a projection. Each of the engaging elements of the base is fitted to and engaged with an engaging element of the shoe and fused thereto bidirectionally in the longitudinal direction.

Here, the number of engagement points between the base and the shoe is increased, increasing the strength of the bond between the base and the shoe. Furthermore the forces due to chain friction and thermal expansion difference are sustained by a plurality of engaging elements, and the amount of shear stress acting on the fused area between back of the shoe and the supporting surface of the base is decreased, further improving the durability of the chain guide.

According to a third aspect of the invention, the engaging portion of the base comprises at least one base groove and at least one base protrusion provided on the supporting surface of the base. The grooves and protrusions are arranged in alternation along the longitudinal direction. The engaging portion of the shoe comprises the same number of shoe protrusions as the number of base grooves and the same number of shoe grooves as the number of base protrusions. The shoe protrusions and shoe grooves are provided on the back face of the shoe and arranged in alternation along the longitudinal direction. The base grooves, the base protrusions, the shoe protrusions, and the shoe grooves, all extend in a lateral direction transverse to the longitudinal direction. The base grooves and the shoe protrusions are engaged, and fused with one another bidirectionally in the longitudinal direction, and the base protrusions and the shoe grooves are also engaged, and fused with one another bidirectionally in the longitudinal direction.

Here, the area of the engaging portions in the lateral direction can be increased without increasing the width of the chain guide in the lateral direction. Thus, it is possible to increase the strength of the bond between the base and the shoe significantly. Forces due to chain friction and thermal expansion difference are sustained by the guide engaging portions, decreasing the shear stress acting on the fused area between the back of the shoe and the supporting surface of the base, and thereby improving the durability of the chain guide.

In accordance with a fourth aspect of the invention, the engaging portion of the base comprises at least one lattice-shaped engaging portion and the engaging portion of the shoe comprises at least one lattice-shaped engaging portion. The at least one lattice-shaped engaging portion of one of the base and the shoe is a lattice-shaped groove structure composed of at least one longitudinal groove extending in the longitudinal direction and at least one lateral groove extending in a lateral direction transverse to the longitudinal direction, the grooves intersecting one another. The at least one lattice-shape engaging portion of the other of the base and the shoe is a lattice-shaped protrusion structure composed of at least one longitudinal protrusion extending in the longitudinal direction and at least one lateral protrusion extending in a lateral direction transverse to the longitudinal direction, said protrusions also intersecting one another. Each longitudinal protrusion fits a longitudinal groove of the groove structure and each lateral protrusion fits a lateral groove of the groove structure. The lattice-shaped engaging portions are fused to each other bidirectionally both in the longitudinal direction and in the lateral direction.

Here, the total area of engagement both in the lateral direction and in the longitudinal direction can be increased without increasing the width of the chain guide in the lateral direction. Thus, it is possible to increase the overall strength of the bond between the base and the shoe.

The lateral protrusions and the lateral grooves sustain forces due to chain friction and thermal expansion difference, relieving shear stress acting on the mutually facing fused areas of the back of the shoe and the supporting surface of the base and improving the durability of the chain guide.

Shear forces acting in the lateral direction are sustained by the cooperation of the one or more longitudinal protrusions and grooves, further increasing the durability of the chain guide.

Manufacture of the guide is also improved by reason of the fact that, in molding the element on which the longitudinal protrusion or protrusions are formed, resin flows more smoothly in the longitudinal mold cavity or cavities in which the longitudinal protrusion or protrusions are formed.

The transmission chain guide according a fifth aspect of the invention is pivotally supported for swinging movement about a pivot axis, and comprises a projecting portion integrally molded with the shoe and extending from the base in a direction parallel to said axis toward an adjacent member. The projecting portion extends from the base by a distance such that, when the chain guide becomes inclined with respect to a plane orthogonal to the pivot axis, the projecting portion comes into contact with the adjacent member before the base and the shoe can come into contact with the adjacent member.

Contact between the projecting portion and an adjacent member such a timing chain cover or an engine block, prevents or mitigates abrasion and damage to the guide base or the shoe caused by its coming into contact with the adjacent member. A shock-absorbing effect is achieved by the elasticity of the synthetic resin of which the projecting portion is made. Thus, the durability of the chain guide is increased. Furthermore, noise caused by contact between the chain guide and the adjacent member is reduced. Because the projecting portion is made of the same synthetic resin as the shoe, which needs to be abrasion-resistant, the projecting portion itself is also abrasion-resistant and contributes to improved durability of the chain guide while maintaining its shock-absorbing effect over a long time.

According to a sixth aspect of the invention, the projecting portion comprises an intruding portion extending into the base in a direction orthogonal to the longitudinal direction, and the intruding portion is engaged with the base, and fused to the base bidirectionally in the longitudinal direction.

Here the projecting portion, not only serves to absorb shock and protect the guide, but also, by virtue of its bidirectional fusion to the base, assists in sustaining shear stress due to forces resulting from chain friction and thermal expansion differences, thereby still further improving the durability of chain guide.

### BRIEF DESCRIPTION OF DRAWINGS

FIG. 1A is a schematic elevational view of an engine timing transmission having a movable chain guide in accordance with the invention;

FIG. 1B is a cross-sectional view taken on section plane b-b in FIG. 1A;

FIG. 2 is a perspective view of the movable chain guide shown in FIGS. 1A and 1B;

FIG. 3 is an exploded perspective view of the movable chain guide shown in FIGS. 1A and 1B;

FIG. 4 is a cross-sectional view taken on section plane IV-IV in FIG. 1A;

FIG. 5 is a cross-sectional view taken on section plane V-V in FIG. 1A;

FIG. 6 is an exploded view, corresponding to FIG. 3, and showing a first variation of the chain guide;

FIG. 7 is a sectional view, corresponding to FIG. 4, and showing the first variation of the chain guide;

FIG. 8 is an exploded perspective view, corresponding to FIG. 3, and showing a part of a chain guide according to a second embodiment of the invention; and

FIG. 9 an exploded perspective view, corresponding to FIG. 3, and showing a part of a chain guide according to a third embodiment of the invention.

### DETAILED DESCRIPTION OF THE PREFERRED EMBODIMENTS

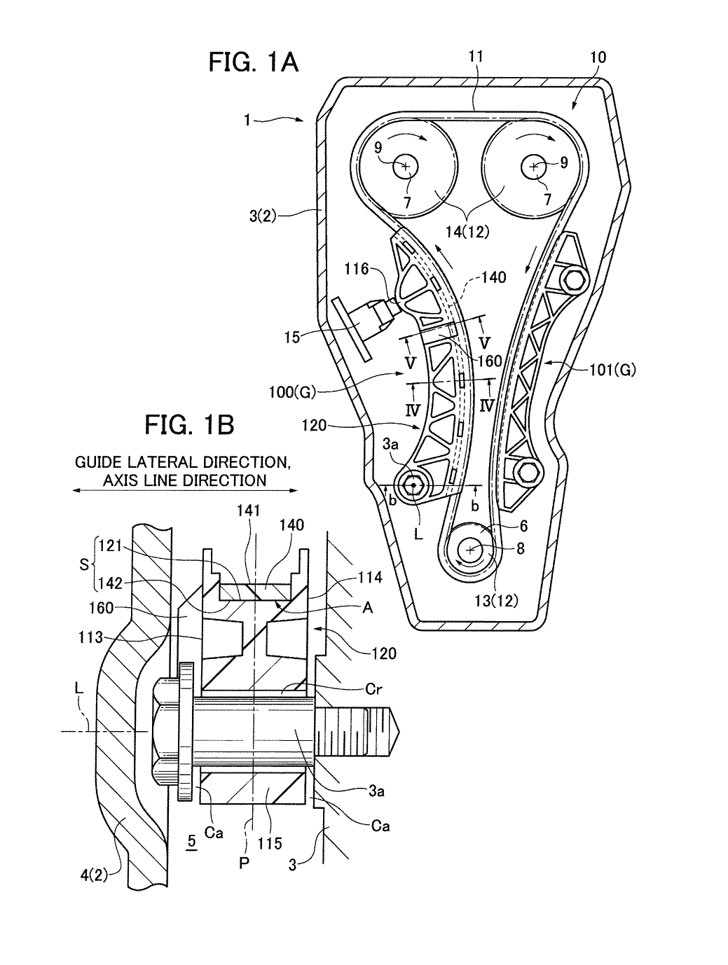

Referring to FIG. 1, in an internal combustion automobile engine 1 having a timing transmission 10, guides G are provided to guide an endless traveling timing chain 11. The chain is driven by a sprocket 13 on the engine crankshaft 6, which is rotatable on axis 8, and rotates a pair of sprockets 14 on valve-operating camshafts 7, which are rotatable on axes 9.

One of the guides G is a movable chain guide 100 according to a first embodiment of the invention. The movable chain guide is in sliding engagement with the slack side of the transmission chain 11, i.e., the span of the chain that travels from the crankshaft sprocket 13 toward one of the two camshaft sprockets 14. A chain tensioner 15 exerts a force against the movable guide to maintain proper tension in the chain. The other guide G is a fixed guide 101, which is in sliding engagement with the tension side of the chain, i.e., the span that travels from the other camshaft sprocket 14 toward the crankshaft sprocket 13.

The chain guide 100 is pivotally supported on a shaft 3a, which fixed to the engine block. The guide 100 can swing about a pivot axis L, which is parallel to the crankshaft axis 8 and to the camshaft axes 9.

The timing transmission 10 is disposed within an oil-tight space 5 (FIG. 1B) defined by the engine block, including a wall 3 protruding as an integral part from the engine block, and a chain cover 4 (FIG. 1B). The timing transmission is lubricated by oil supplied from the engine oil pump (not shown), or from another suitable supply, through an oil port or oil jet (not shown). Thus, the chain 11, sprockets 13 and 14, and the chain guides 100 and 101 are installed in space in which plenty of lubricating oil is present. The lubricating oil adheres as oil droplets to the chain 11, the sprockets 13 and 14, and the chain guides 100 and 101.

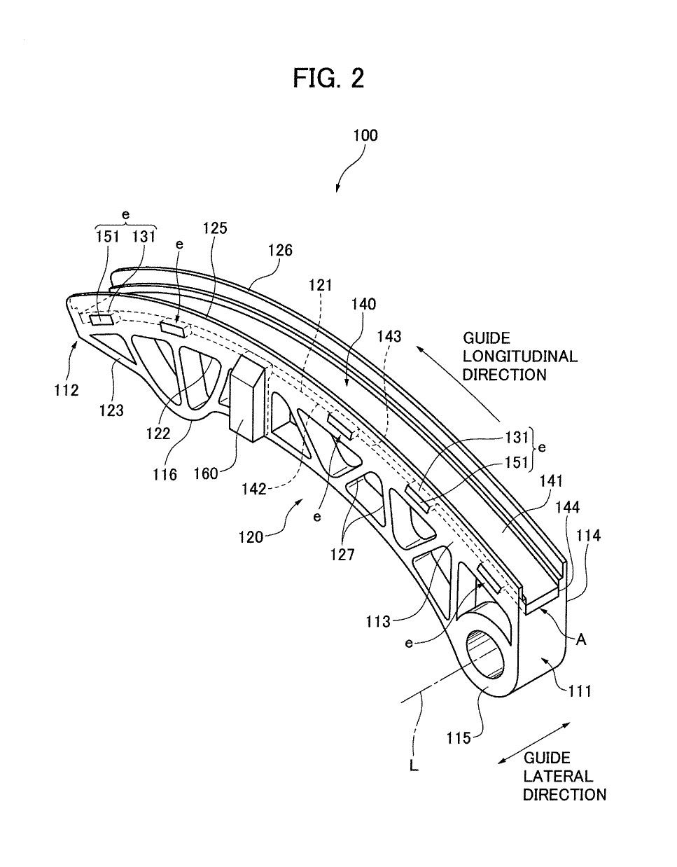

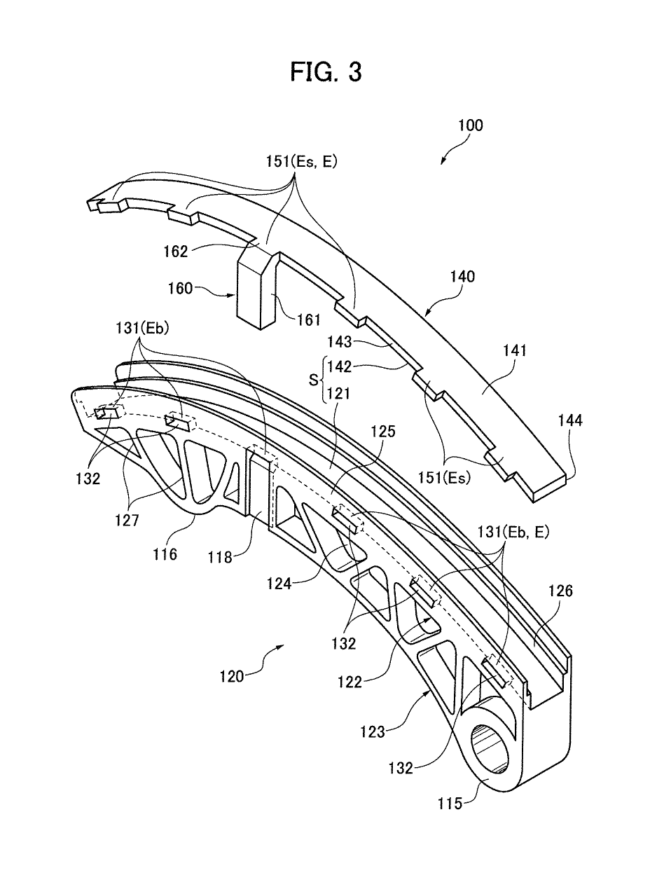

Referring now to FIGS. 1B, 2 and 3, the chain guide 100 includes a base 120, made of a synthetic resin, which is elongated and extends in the longitudinal direction of the guide. The guide also comprises an elongated shoe 140, also made of a synthetic resin. The shoe is supported by the base 120, and also extends in the longitudinal direction of the guide. The shoe includes a projecting portion 160, made of synthetic resin, which projects in a lateral direction from the shoe and extends downward in FIGS. 2 and 3, in the direction of the height of the guide. The shoe 140 and the projecting portion 160 are fixed to, and integrated with, the base 120.

The longitudinal direction of the guide 100 is the direction along which the chain 11 (FIG. 1) travels on the guide. The lateral direction of the guide is a direction parallel to the pivot axis L (FIGS. 1A, 1B, and 3) and the crankshaft and camshaft axes 8 and 9. The height direction of the guide is a direction orthogonal both to the longitudinal direction and to the lateral direction.

The base 120 has a rigidity greater than that of the shoe 140. As shown in FIG. 3, the base has a supporting face 121 for supporting the back face 142 of the shoe 140 along the entire length of the guide in the longitudinal direction. In the embodiment shown in FIG. 3, the supporting face contacts the entire surface of the shoe. The shoe 140 has a sliding contact surface 141 on which link plates (not shown) of the chain 11 slide as the chain 11 travels along the longitudinal direction of the guide. As shown in FIG. 1B, the shoe-supporting face 121 and the back face 142 constitute an interface S between the base 120 and the shoe 140.

As shown in FIG. 1B, at the interface S the base 120 and the shoe 140 are fused together over a fused area A transverse to the direction of the height of the guide.

The shoe 140 is a plate-like member having an approximately uniform thickness. The projecting portion 160 is integrally molded with the shoe 140. The base 120, the shoe 140, and the projecting portion 160, are integrated by being fused together, using a two-material molding process. In the two-material molding process, using a metal mold, the base 120 is formed in a first injection molding operation, and the shoe 140 and the projecting portion 160 are then formed in a second injection molding operation. Alternatively, the shoe 140 and the projecting portion 160 can be formed in a first injection molding operation and the base 120 can then be formed in a second injection molding operation.

The synthetic resin from which the base 120, the shoe 140 and the projecting portion 160 are made can be, for example, a polyamide resin or a polybutylene terephthalate resin. The synthetic resin from which the base 120 is molded has a strength higher strength than that of the synthetic resin from which the shoe 140 is molded. An example of a synthetic resin material for the base is fiber-reinforced polyamide resin, including glass fibers. The fiber-reinforced resin is strong and highly resistant to abrasion. The synthetic resin for the shoe should also be highly abrasion-resistant, and should be a self-lubricating synthetic resin such as a polyamide resin, e.g., polyamide-66, or wholly aromatic resin. Synthetic resin from which the projecting portion 160 is molded is also highly abrasion-resistant, and should be more flexible than the synthetic resin of the base. The synthetic resin for the projecting portion can have the same composition as that of the synthetic resin from which the shoe is molded. In the embodiment described, the synthetic resin of the shoe has a thermal expansion coefficient higher than that of the synthetic resin of the base.

Referring to FIGS. 2 to 4, the shoe side of the base 120 is formed with a flange 122 having the shoe-supporting face 121. A flange 123, having a back face 123a, is connected to the shoe side flange 122 by a web 124 and disposed opposite to the shoe-side flange. The base is formed with a pair of side walls 125 and 126 which stand upright from the shoe side flange 122. These side walls restrict meandering of the chain 11. Reinforcing ribs 127 and 128 are arranged on opposite sides of the web 125 in the lateral direction of the guide, and connecting flanges 122 and 123, and the web 124.

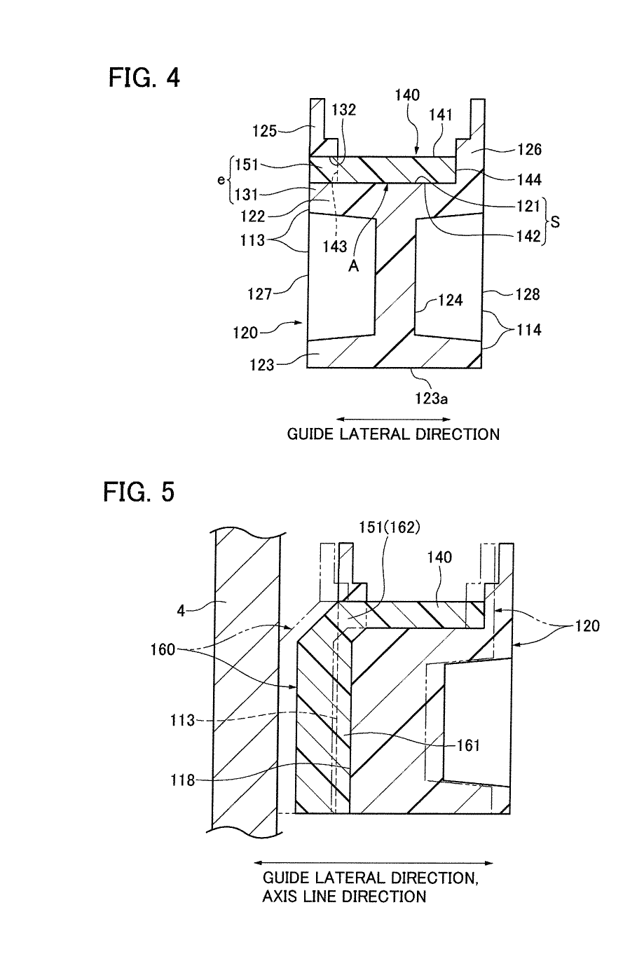

As shown in FIG. 2, longitudinally opposite end portions of the flanges 122 and 123, the web 124, and the side walls 125 and 126, respectively constitute a chain entry end 111 and a chain exit end 112 of the guide 100. As shown in FIG. 4, laterally opposite side faces of the flanges 122 and 123, the side walls 125 and 126, and the reinforcing ribs 127 and 128, constitute a pair of side faces 113 and 114 of the base 120.

The shoe-supporting face 121 is positioned between side walls 125 and 126 that face each other in the lateral direction. Flange 123 of the base is formed with a boss 115 (FIGS. 1B, 2, 3, and 4), which is a portion supported by shaft 3a (FIG. 1B), at the chain entry end 111. The flange 123 is also formed with an abutment 116 adjacent the chain exit end 112. The plunger of chain tensioner 15 (FIG. 1A) exerts a force against the abutment, urging the sliding contact surface of the shoe against the chain 11.

One or more (preferably two or more) holes 131 are provided in side wall 125. These holes 131 are aligned with one another and disposed at intervals along the longitudinal direction of the guide. The walls of holes 131 serve as engaging surfaces Eb for engagement with projections on the shoe. Each of these holes is a through hole having an opening 132 in the lateral outside surface of the wall 125. Holes 131 extend in the lateral direction of the guide, and each of the holes 131 receives a projection 151 of the shoe.

The laterally opposite side edges of the shoe are in the form of side faces 143 and 144. As shown in FIG. 3, the side face 143 is formed with integrally molded projections 151 at intervals corresponding to the intervals of the holes 131 in the base. Each of the projections 151 fits into a hole 131 in the base, with its outer surface Es fitting a surface Eb of a hole 131.

The surfaces Eb and surfaces Es can be referred to collectively as a guide engaging portion E. The base holes 131 and the projections 151 can be referred to collectively as a guide engaging element e.

The cross-sectional shape of the holes 131 and the shoe projections 151, in section planes parallel to an imaginary longitudinal plane P orthogonal to the pivot axis L (FIG. 1B), is a rectangle elongated in the longitudinal direction of the guide. The elongation of the projections 151 makes it possible to reduce the height of the base 120 while maintaining stiffness in the projection 151.

At each of the guide engaging elements e of the chain guide 100, the base 120 and the shoe 140 are integrated by fusion. Each projection 151 and the base hole 131 into which it fits, are fused to each other bidirectionally, both in the longitudinal direction and in the guide height direction. That is, the upper and lower surfaces of the projection 151 are fused respectively to the upper and lower surfaces of the hole 131, and the front and rear ends of the projection 151 are likewise fused respectively to the front and rear ends of the hole 131. Thus, at each of the engaging elements e, there is no clearance between the base hole 131 and the projection 151 that would allow a projection 151 to move either longitudinally or in the guide height direction relative to the hole 131.

Side walls 125 and 126 of the base, are respectively engaged with, and fused to, side face 143 and 144 of the shoe, so that the shoe and base are also fused bidirectionally in the lateral direction. Thus, when a lateral shear stress acts on the transverse fused area A (FIG. 1B) due to friction between the shoe and the chain, or to a difference in thermal expansion, the shear stress is resisted not only by the fused relationship between the shoe and the base over area A, but also by the bidirectionally fused engagement the side walls 125 and 126 with the pair side faces 143 and 144. Therefore, the overall resistance of the guide to shear stress is improved.

As shown in FIG. 1B, the shaft 3a is formed by a bolt threaded into the wall of an engine block. There is a radial direction clearance Cr between the boss 115 of the pivoted guide and shaft 3a, and an axial clearance Ca between one end of the boss 115 and the wall of the engine block and between the other end of the boss the head of the bolt. These clearances Cr and Ca are exaggerated in IFG. 1A for the purpose of illustration.

Referring to FIGS. 2, 3 and 5, the projecting portion 160 on the base 120 projects from the side face 113, which faces the chain cover 4 in the lateral direction. The projecting portion 160 extends in the guide height direction in the embodiment described, but may have any of various other shapes.

As shown in FIGS. 1A and 2, the projecting portion 160 is located on the guide adjacent, but on the chain entry side of, the tensioner abutment 116. The extent to which the projecting portion 160 protrudes laterally can be determined in accordance with the lateral distance between the base 120 and the chain cover 4.

As shown in FIG. 3, the projecting portion 160 includes an intruding portion 161 which intrudes into the base 120, and a connecting portion 162, which extends from the shoe 140 in the lateral direction of the guide and connects the shoe 140 with the intruding portion 161.

Referring again to FIG. 3, The intruding portion 161 is engaged with, and welded to, the walls of a concave depression 118 in the base 120. This depression has an opening in the lateral direction of the guide. The intruding portion is welded to opposite walls of the depression and thereby secured bidirectionally in the longitudinal direction of the guide. The intruding portion is secured to the base unidirectionally in the lateral direction of the guide.

The connecting portion 162 extends laterally through the side wall 125 of the base. In the embodiment shown in FIG. 3, the connecting portion 162 is identical to the shoe projections 151.

The chain cover 4 is located closely adjacent the base 120, being spaced therefrom by only a short distance in the lateral direction of the guide. Because of the clearances Cr and Ca (FIG. 1B), the guide 120 can become inclined relative to imaginary plane P. These clearances allow the guide to become inclined by tilting so that the chain exit end moves farther than the chain entry end from plane P, or by rotation about an axis extending generally in the direction of elongation of the guide. These modes of tilting can also be combined. In addition, clearance Ca allows some translational movement of the guide along the axis of the shaft 3a.

When the guide becomes inclined, the projecting portion 160 comes in contact with the chain cover 4 before the base 120 can contact the chain cover, as shown by two dash broken line in FIG. 5. Thus, the projecting portion 160 of the shoe prevents the base 120 from colliding with the chain cover.

The chain guide 100 exhibits a number of advantages over conventional chain guides. First, because the base and the shoe are both made of synthetic resin and are fused together, it is possible to produce a light-weight chain guide efficiently.

With the surfaces Eb of the base 120 fused to the surfaces Es of the shoe 140 bidirectionally in the longitudinal direction, i.e., a fused interface exists at each of the two longitudinal separated ends of a shoe projection 151, the base and the shoe 140 combined by fusion not only at the transverse fused area A, but also at a guide engaging portion E, composed of the base engaging surfaces Eb and the shoe engaging surfaces Es. Thus, the total fused area is increased, and the strength of the bond between the base and the shoe is also increased.

Longitudinal shear tress, due to friction between the chain and the shoe and to differential thermal expansion of the shoe and the base, is sustained not only at the fused area A but also by the bidirectionally fused guide engaging portion E. Thus, the durability of the guide is improved, and maintenance requirements are reduced.

In some conventional chain guides, a longitudinal clearance allows collision between a base engaging surface and a shoe engaging surface as a result of fluctuations in friction caused by fluctuations in chain tension, or fluctuations in thermal expansion differences caused by repeated temperature changes. However, in the chain guide of the invention, the base engaging surfaces Eb and the shoe engaging surfaces Es are fused together and therefore always remain in close contact with each other. Thus these collisions are prevented, and noise caused by the collisions is avoided. Abrasion of the base engaging surfaces Eb and the shoe engaging surfaces Es caused by the collisions is also prevented, resulting in improved durability of the chain guide.

Because the guide includes a plurality of base holes 131 constituting the base engaging surfaces Eb, and an equivalent number of the shoe projections 151 constituting the shoe engaging surfaces Es, the number of points of engagement between the base and the shoe is increased, and the strength of the bond between the shoe and the base is increased.

When the base holes 131 and shoe projections 151 are engaged bidirectionally in the longitudinal direction of the guide to constitute guide engaging elements e, the forces due to chain friction and thermal expansion differences are sustained by a plurality of guide engaging elements e. Thus, the amount of shear stress applied to the fused area A is decreased, and the durability of the chain guide is improved.

When the chain guide is inclined, the projecting portion 160 initially comes into contact with the chain cover, preventing, or at least mitigating, abrasion and resulting damage to the base 120 or the shoe 140 by virtue of the shock-absorbing effect resulting from the elasticity of the synthetic resin of which the projecting portion 160 is made. The projecting portion therefore increases the durability of the chain guide and also reduces the noise caused by contact between the chain guide and the chain cover. Furthermore, because the projecting portion 160 is made of the same synthetic resin as the shoe 140, which needs to be abrasion-resistant, the abrasion resistance of the projecting portion contributes to improved durability of the chain guide while maintaining a shock-absorbing effect for a long time.

The intruding portion 161 of the projecting portion 160, which intrudes laterally into the base 120 is also engaged with and fused to the base 120 bidirectionally in the longitudinal direction of the guide. Thus the projecting portion 160 also contributes to the decrease in the amount of shear stress acting on the fused area A, still further improving the durability of chain guide 100.

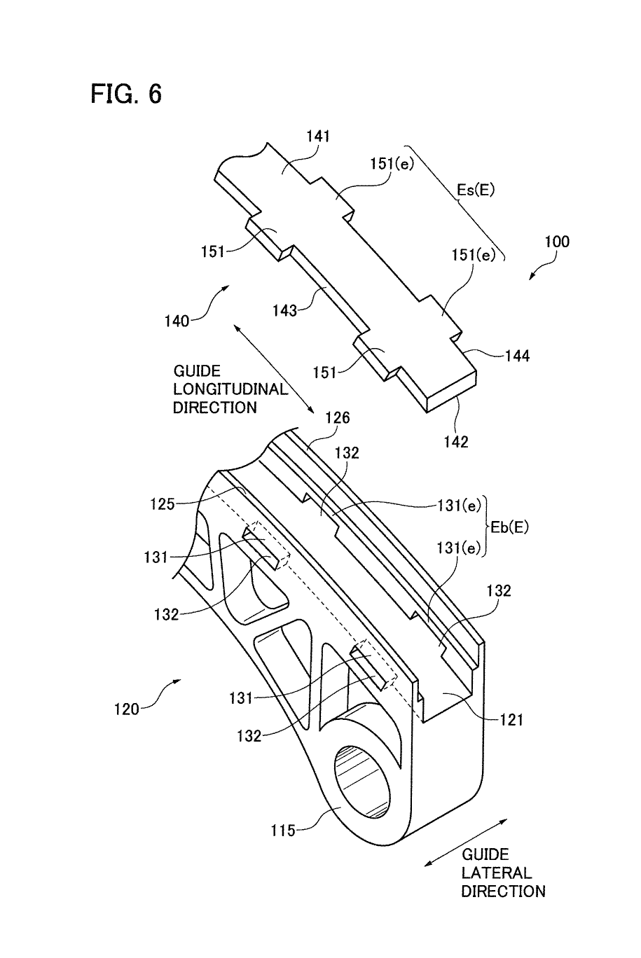

Variations of the first embodiment, and second and third embodiments of the invention and variations thereof, are described below, with reference to FIGS. 6 to 9. The same reference numbers are used to designate parts corresponding to parts of the first embodiment.

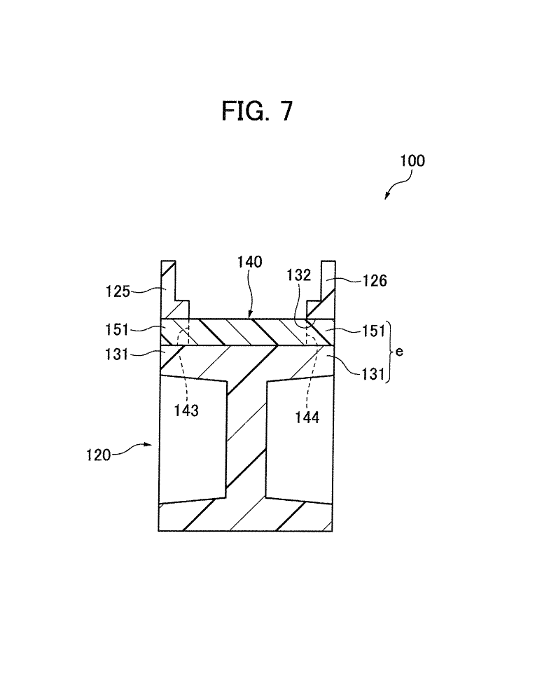

In a first variation, depicted in FIGS. 6 and 7, holes 131, having openings 132, are formed in both side walls 125 and 126, and projections 151 are formed on both sides 143 and 144 of the shoe. Each projection 151 fits into a hole 131, as shown in FIG. 7, being fused bidirectionally both in the longitudinal direction of the guide and in the height direction. Because holes 131 and shoe projections 151 are provided on both sides of the guide, the number of engagement points between the base 120 and the shoe 140 is increased, and the bond between the shoe and the base at area A, where the back of the shoe is fused to the shoe-supporting face of the base, is supplemented by the fused engagement of the projections 151 with holes 131 on both sides of the guide. Consequently the guide is highly resistant to shear stress resulting from friction between the chain and the shoe and from differences in the thermal expansion of the shoe and the base.

In another variation of guide, the engaging portion of the base Eb may consist of laterally inward-extending projections formed on the side walls of the base while the engaging portion of the shoe Es may consist of recesses formed along the sides of the shoe for receiving the inward-extending projections of the base.

Alternatively the engaging portion of the base may consist of a combination of holes and inward-extending projections while the engaging portion of the shoe Es consists of a combination of protrusions extending into the holes of the engaging portion of the base, and recesses receiving the inward-extending projections of the base.

The holes in the side walls of the base, and the recesses in the shoe can have various shapes other than longitudinally elongated, rectangular shapes. For example the holes or recesses can be in the form of concave recesses, grooves or cut-away shapes. Furthermore, the holes and projections may be formed so that they are elongated in the guide height direction.

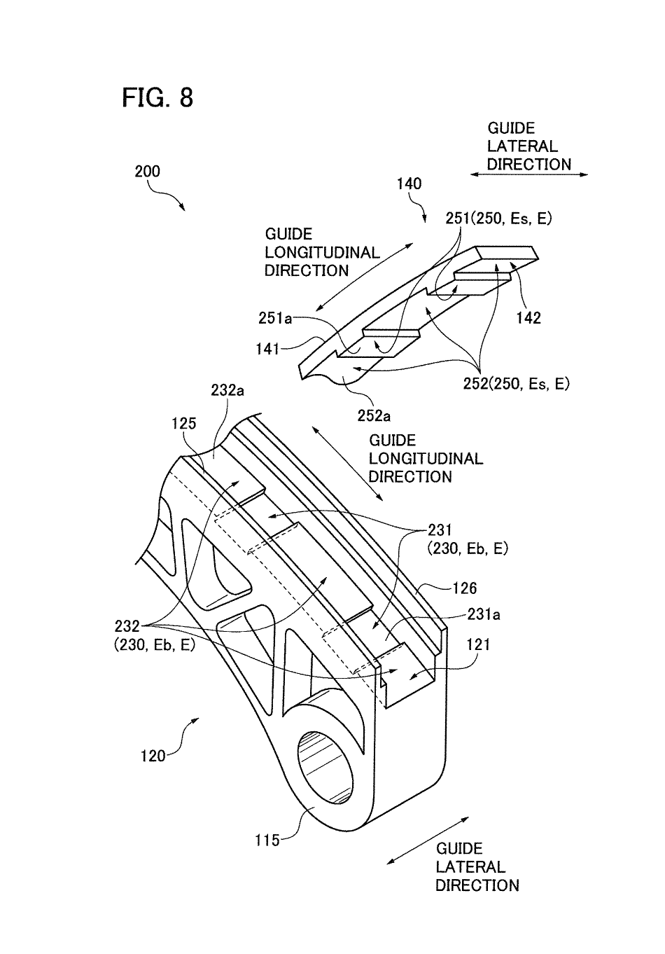

Referring now to FIG. 8, in second embodiment, a chain guide 200, which includes a projecting portion 160 (not shown) as in the chain guide 100, the engaging portion Eb of the base 120 is a support surface 121 having a concave/convex structure 230 which includes one or more grooves 231 and one or more protrusions 232 arranged alternately along the longitudinal direction of the guide. In the embodiment shown, the support surface comprises a plurality of grooves 231 and a plurality of protrusions 232.

The engaging portion Es of the shoe 140 is a back face 142 similarly composed of a concave/convex structure 250 which includes a number of protrusions 251 corresponding to the number of grooves 231 on the base, and a number of grooves 252 corresponding to the number of protrusions 232 on the base. The grooves and protrusions are disposed alternately along longitudinal direction of the guide, and positioned to fit the protrusions and grooves of the base.

In the embodiment illustrated in FIG. 8, the base grooves 231 and the base protrusions 232 extend in the lateral direction through a distance corresponding to the full width of the shoe-supporting surface 121 of the base. However in variations of this embodiment, the base grooves 231 and the base protrusions 232 may extend in the lateral direction over a part of the width of the support face 121 (e.g., by a distance between one-half and the full width of the support face). In still another variation, the base grooves may be divided into laterally spaced groove portions by one or more dividing elements.

The shoe protrusions 251 can similarly extend in the lateral direction through a distance corresponding to the full width of the shoe-supporting surface 121, or through a distance corresponding to a part of the width of the supporting surface. The protrusions may also be divided by grooves into laterally separated parts. In each case, the protrusions and grooves of the base are shaped to fit, respectively, the protrusion and grooves of the shoe. The base grooves 231 and the shoe protrusions 251 are engaged and fused bidirectionally in the longitudinal direction of the guide. The base protrusions 232 and the shoe grooves 252 are likewise engaged and fused bidirectionally in the longitudinal direction of the guide

In this embodiment, the bottom faces 231a of the base grooves 231, the top faces 251a of the shoe protrusions 151, the top faces 232a of the base protrusions 232, and the bottom faces 252a of the shoe grooves 252 constitute a fused area corresponding to fused area A in FIG. 1B at which respective surfaces of the base and the shoe face each other in the direction of the height of the guide.

The base protrusions 232, the base grooves 231, the shoe protrusions 251 and the shoe grooves 252, can have any desired length in the longitudinal direction of the guide, provided that each protrusion fills the groove in which it is disposed so that the protrusions and grooves are fused bidirectionally at least in the longitudinal direction of the guide.

The protrusions and grooves in this embodiment provide for a guide engaging portion E having a larger dimension in the lateral direction of the guide. Consequently, the fusion of the shoe and base can withstand high longitudinal shear stresses due to chain friction and thermal expansion differences without the need to increase the width of the guide, and a higher durability can be achieved.

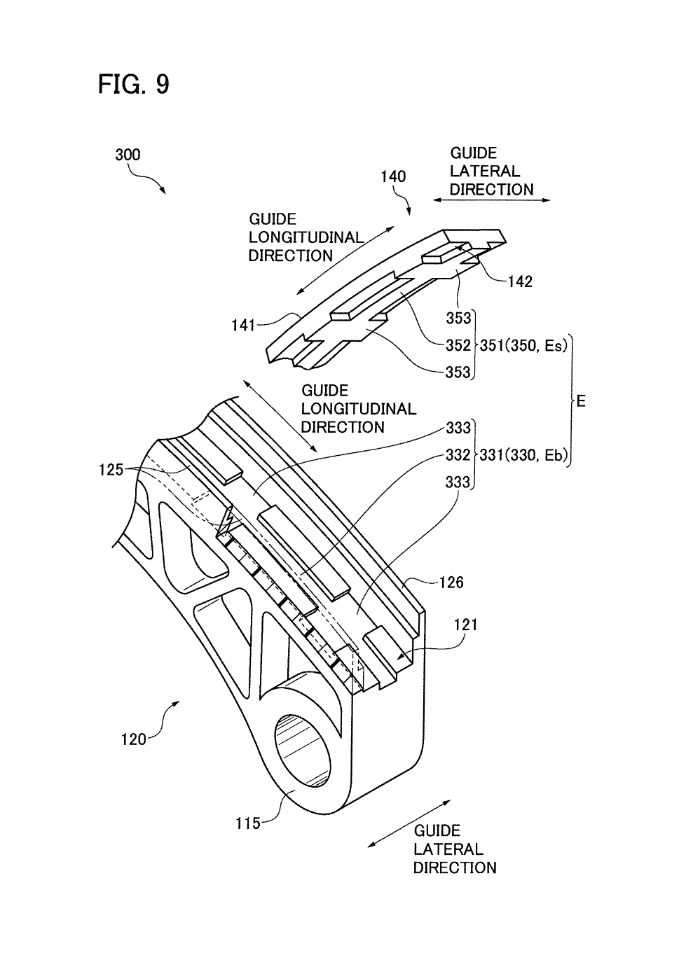

In a third embodiment, illustrated in FIG. 9, a chain guide 300, which includes a projecting portion (not shown) corresponding to the projecting portion 160 in chain guide 100, the engaging portion Eb of the base 120 is a lattice-shaped engaging portion 330 which includes a lattice-shaped groove 331 formed in the surface of the shoe-supporting face 121. The engaging portion Es of the shoe 140 is an engaging portion 350 which includes a lattice-shaped protrusion 351 formed on the back face 142 of the shoe.

Groove 331 is composed of one or more longitudinal grooves and one or more intersecting lateral grooves. In the embodiment of FIG. 9, the grooved 331 is composed of a single longitudinal groove 332 and a plurality of lateral grooves 333.

The lattice-shaped protrusion 351 on the shoe comprises a number of longitudinal protrusions 352 corresponding to the number of longitudinal grooves 332 in the base, intersected by a number of lateral protrusions 353 corresponding to the number of lateral grooves 333 in the base.

The lattice-shaped protrusion of the shoe fits the lattice-shaped groove structure of the base without gaps, and the protrusion and groove structure are fused together bidirectionally both in the longitudinal direction and in the lateral direction.

The number and spacing of the grooves and protrusions can vary, as long as longitudinal grooves 332 of the base fit the longitudinal protrusions 352 of the shoe and the lateral grooves 333 of the base fit the lateral protrusions 353 of the shoe so that the longitudinal grooves and protrusions are fused bidirectionally in the lateral direction and the lateral grooves and protrusions are fused bidirectionally in the longitudinal direction.

In this embodiment, as in the second embodiment shown in FIG. 8, the protrusions and grooves provide for a guide engaging portion E having a large dimension in the lateral direction of the guide. Consequently, the fusion of the shoe and base can enable the guide to withstand high longitudinal shear stresses due to chain friction and thermal expansion differences without the need to increase the width of the guide, and a higher durability can be achieved. In addition, the longitudinal elements of the lattice-shaped protrusion and groove increase the ability of the guide to withstand lateral shear stress, for example lateral shear stress due to thermal expansion difference.

Molding of the shoe in this embodiment is enhanced by the fact that resin can flow readily in a longitudinal mold cavity in which the longitudinal protrusion 352 is formed.

Several variations of the third embodiment are possible. For example, although in the embodiment illustrated in FIG. 9, lattice structures extend over the entire surfaces of the support face 121, and the back face 142 of the shoe, the engaging portions can be composed of plural, separate, lattice structures.

In another variation, the protruding lattice can be formed on the base, and a lattice-shaped groove structure can be formed on the back face of the shoe.

In the first embodiment, the holes and the projections extending in the lateral direction of the guide may be inclined at 45 degrees or less with respect to the lateral direction of the guide. In the second embodiment, the grooves and the protrusions extending in the lateral direction of the guide may also be inclined at 45 degrees or less with respect to the lateral direction of the guide. Likewise, in the third embodiment, the longitudinal grooves and the longitudinal protrusions may be inclined at 45 degrees or less with respect to the longitudinal direction of the guide, and the lateral grooves and the lateral protrusions may be inclined at 45 degrees or less with respect to the lateral direction of the guide. Each of the aforementioned inclination angles is zero degrees when the direction in which the holes, the projections, the grooves or the protrusions extend is in parallel with the longitudinal direction of the guide or the lateral direction of the guide.

In each of the three embodiments, the projecting portion 160 can be provided on the opposite side face 114 to prevent collision between the guide and the engine block. Moreover, projecting portions can be provided on both sides of the guide to prevent collisions especially in a case in which the guide is in close proximity both to the engine block and to the timing chain cover.

Many variations in the guide, and in the transmission in which the guide is utilized, are possible. For example, the transmission chain used with the chain guide according to the invention may be a roller chain, with or without bushings, a link chain, or a silent chain. The chain guide itself may be a movable guide or a fixed guide. The machine in which a chain guide according to the invention is installed may be an automotive engine or other automotive power unit, a non-automotive engine or other non-automotive power unit, an industrial machine, or a conveyor or other transporting device.

The shoe and base of the guide can be fused to each other by various means including, for example, two-material molding, ultrasonic welding, heat, or vibration.

What is claimed is:

1. A transmission chain guide comprising:
a shoe made of synthetic resin and extending in a longitudinal direction, said shoe having a front face for sliding engagement with a transmission chain traveling in said longitudinal direction, and a back face; and
a base made of synthetic resin and having a supporting face extending along said longitudinal direction and supporting said back face of the shoe, the shoe and the base being integrally fused together;
an engaging portion of the base integrally molded with the base; and
an engaging portion of the shoe integrally molded with the shoe;
the engaging portion of the base and the engaging portion of the shoe being engaged and fused with each other bidirectionally in said longitudinal direction.

2. The transmission chain guide according to claim 1, wherein:
the engaging portion of the base comprises a plurality of engaging elements in spaced relationship along the longitudinal direction of the guide;
the engaging portion of the shoe comprises a number of engaging elements equal to the number of said engaging elements of the base, in spaced relationship along the longitudinal direction of the guide;
each of the engaging elements of the base is one of a hollow space and a projection;
each of the engaging elements of the shoe is one of a hollow space and a projection; and
each of said engaging elements of the base is fitted to and engaged with an engaging element of the shoe and fused thereto bidirectionally in said longitudinal direction.

3. The transmission chain guide according to claim 1, wherein:
the engaging portion of the base comprises at least one base groove and at least one base protrusion provided on the supporting surface of the base, the grooves and protrusions being arranged in alternation along said longitudinal direction;
the engaging portion of the shoe comprises the same number of shoe protrusions as the number of base grooves, and the same number of shoe grooves as the number of base protrusions, said shoe protrusion and shoe grooves being provided on the back face of the shoe and arranged in alternation along said longitudinal direction;
the base grooves, the base protrusions, the shoe protrusions and the shoe grooves all extend in a lateral direction transverse to said longitudinal direction;
the base grooves and the shoe protrusions are engaged, and fused with one another bidirectionally in said longitudinal direction; and
the base protrusions and the shoe grooves are engaged, and fused with one another bidirectionally in said longitudinal direction.

4. The transmission chain guide according to claim 1, wherein
the engaging portion of the base comprises at least one lattice-shaped engaging portion;
the engaging portion of the shoe comprises at least one lattice shaped engaging portion;
said at least one lattice-shaped engaging portion of one of said base and said shoe is a lattice-shaped groove structure composed of at least one longitudinal groove extending in said longitudinal direction and at least one lateral groove extending in a lateral direction transverse to said longitudinal direction, said grooves intersecting one another;
said at least one lattice-shape engaging portion of the other of said base and said shoe is a lattice-shaped protrusion structure composed of at least one longitudinal protrusion extending in said longitudinal direction and at least one lateral protrusion extending in a lateral direction transverse to said longitudinal direction said protrusions intersecting one another;
each said longitudinal protrusion fits a longitudinal groove of said groove structure and each said lateral protrusion fits a lateral groove of said groove structure; and
the lattice shaped engaging portions are fused to each other bidirectionally both in said longitudinal direction and in said lateral direction.

5. The transmission chain guide according to claim 1, wherein:
the chain guide is pivotally supported for swinging movement about an axis;
the chain guide further comprises a projecting portion integrally molded with the shoe and extending from the base in a direction parallel to said axis toward an adjacent member; and
the projecting portion extends from the base by a distance such that, when the chain guide becomes inclined with respect to a plane orthogonal to said axis, the projecting portion comes into contact with said adjacent member before the base and the shoe can come into contact with said adjacent member.

6. The transmission chain guide according to claim 5, wherein:
the projecting portion comprises an intruding portion extending into the base in a direction orthogonal to said longitudinal direction; and
said intruding portion is engaged with the base, and fused to the base bidirectionally in said longitudinal direction.
